(19) United States
(12) Patent Application Publication
(10) Pub. No.: US 2018/0182507 A1
(43) Pub. Date: Jun. 28, 2018

(54) Continuously Transposed Conductors And Assemblies

(71) Applicant: Essex Group, Inc., Atlanta, GA (US)

(72) Inventors: Bogdan Gronowski, Fort Wayne, IN (US); David Marshall Cain, Easley, SC (US); Matthew Leach, Fort Wayne, IN (US); Christopher Richardson, Fort Wayne, IN (US); Jason Dennis Stephens, Fort Wayne, IN (US)

(21) Appl. No.: 15/848,240

(22) Filed: Dec. 20, 2017

Related U.S. Application Data
(60) Provisional application No. 62/437,921, filed on Dec. 22, 2016.

(51) Int. Cl. H01B 7/00; H02K 3/04; H01F 27/28; H01F 27/34; H02K 3/42

(52) U.S. Cl. CPC H01B 7/0009; H02K 3/04; H02K 3/42; H01F 27/34; H01F 27/2823

(57) ABSTRACT

A continuously transposed conductor (CTC) cable may include a plurality of electrically insulated strands arranged in two stacks with the plurality of strands successively transposed between the two stacks. Each strand may include a conductor and insulation formed at least partially around the conductor. Additionally, each strand may have a cross-sectional area that is less than approximately 0.0030 square inches. As a result, the CTC cable may be suitable for use in electrical devices relatively smaller than those associated with conventional CTC cables.

### CROSS-REFERENCE TO RELATED APPLICATION

This application claims priority to U.S. Provisional Application No. 62/437,921, filed Dec. 22, 2016 and entitled “Continuously Transposed Conductors and Assemblies,” the contents of which is incorporated by reference herein in its entirety.

### TECHNICAL FIELD

Embodiments of the disclosure relate generally to continuously transposed conductors and, more particularly, to continuously transposed conductors having relatively small cross-sectional areas.

### BACKGROUND

The two principal types of electrical losses in electric machines, such as rotating electric motors, are iron losses and conductor losses. Iron losses typically occur in a laminated stator core, while conductor losses are often associated with the conductor winding. These losses can significantly reduce efficiency of the electrical machine. Due to their inadvertent impact on the size of the machine, the losses may also indirectly decrease efficiency and require a machine to be sized up to achieve a desired output and/or to keep the temperature of a winding constrained. Thus, the losses may not only increase the operating cost of a machine, but also the construction cost of the machine and/or a system in which the machine is used.

Conductor losses (also referred to as Joule's losses) typically result from conductor (e.g. copper, aluminum, etc.) resistance to the flow of current through a winding. The conductor losses often result in unwanted heating of the conductor. At relatively low frequencies of alternating current flowing through the conductor, the resulting magnetic flux is relatively small and subsequently, the current distributes itself relatively evenly throughout the entire volume of the conductor. As the frequency of the current increases, the resulting magnetic flux increases and manifests itself in the appearance of induced voltage loops or eddies in the conductor. The main current at the surface of the conductor becomes reinforced and, at the same time, decreases in the center. As a result, the current density throughout the volume of the conductor becomes nonhomogeneous, decreasing towards the center of the conductor and increasing towards its periphery, shell, or outer surface. This effect is often referred to as the skin effect, and the skin depth or depth of penetration of the current density decreases as the frequency of the current increases. The skin effect reduces the effective cross-section of the conductor, thereby causing the effective resistance of the conductor to increase and enhancing conductor losses.

Losses related to the skin effect may be mitigated by decreasing the cross section of the conductor, and at the same time increasing the number of the conductors. The sum of the cross sections of a multitude of conductors should amount to the cross section of the original single conductor, and therefore preserve the current carrying capacity for direct and low frequency currents. This approach creates a multi-strand conductor in which the strands are electrically connected in parallel and, in certain situations, can increase the effective cross section and the combined current carrying for high frequency currents.

However, the above analysis is complicated when other conductors are positioned near a conductor, such as other conductors existing in the slots of an electric machine or other conductors included in a multistrand solution. The magnetic field associated with each conductor (or strand) transmitting a current disturbs the current distribution in the other conductors and/or other metallic parts in the electric machine. This effect is generally called the proximity effect, which typically manifests itself in three distinct types. A direct proximity effect occurs when two or more conductors carry currents in the same direction. The current densities in two conductors decrease at the surfaces that face one another and increase on the opposite sides. This is caused by the enhancement of the inductances on the adjacent surfaces of the conductors that push the respective currents to the region in which the inductance, and therefore, the impedance is lower. An inverse proximity effect occurs when two or more conductors carry currents in the opposite directions. The current densities on the surfaces of two conductors which face each other increase, and the current densities decrease on the opposite side. This is caused by weakening of inductances on the adjacent surfaces of the conductors due to the cancellation of the mutual inductance on the inner sides of the conductors. This attracts the respective currents to the region in which the inductance, and therefore, the impedance is lower. An induced proximity effect occurs as a result of induction of voltages on metallic parts of the machine other than the winding. With proximity effect, it should be noted that the total current density of each of the conductors remains unchanged. The proximity effect becomes increasingly more significant and additionally more complex with the increasing number of the strands in a multistrand assembly. This effect coexists with the skin effect and creates a very complex distribution of the current densities in the conductors.

Proximity effect and skin effect are the sources of circulating current losses or eddy current losses in the strands and subsequently in the stator winding. The total loss in the winding may be approximated by the combination of eddy current losses and the resistive Joule's loses. Because of these circulating currents, addressing the skin effect by designing a multistrand assembly is not sufficient to fully reduce the total loss. Accordingly, continuously transposed conductors (“CTCs”) have been implemented to further reduce losses in a multistrand assembly. A CTC or CTC cable includes individually insulated strands that are typically arranged into two interposed stacks, and each strand is transposed in turn to each position within the cable. Each strand may successively and repeatedly take on each possible position within a cross-section of the CTC cable. As a result, each strand is effectively exposed to similar electromagnetic forces and losses are reduced in the winding. CTC constructions have conventionally been utilized in large transformers and generators. However, there is an opportunity to implement CTC's in relatively smaller electric machines and/or other applications, such as inverter supplied motors intended, for example, for automotive applications.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIG. 1 is a perspective view of an example CTC cable, according to an illustrative embodiment of the disclosure.

FIGS. 2A-2B are cross-sectional views of example CTC strand transpositions, according to illustrative embodiments of the disclosure.

FIGS. 3A-3C are cross-sectional views of example CTC cable strands or conductors, according to illustrative embodiments of the disclosure.

FIGS. 4A-4B illustrate example cross-sectional views of CTC strands that include a plurality of joined conductors, according to various illustrative embodiments of the disclosure.

FIGS. 5A-5F illustrate example cross-sectional shapes that may be utilized in association with CTC strands, according to various illustrative embodiments of the disclosure.

FIG. 6 illustrates a flow chart of an example method for forming a strand of a CTC cable, in accordance with an illustrative embodiment of the disclosure.

FIG. 7 illustrates a flow chart of an example method for forming a CTC cable, in accordance with an illustrative embodiment of the disclosure.

### DETAILED DESCRIPTION

Various embodiments of the present disclosure are directed to continuously transposed conductors (“CTCs”) and/or CTC cables in which individually insulated conductors are formed with a relatively small cross-section. Although CTCs have been commonly used in large transformer and large generators utilizing form wound coils and half coils (i.e. stator bars), relatively smaller CTCs suitable for use in other types of applications are described herein. For example, a CTC may be utilized in applications having much smaller alternating current (“AC”) generators, rotating electric machines, motors, load reactors, inductors, transformers (e.g., relatively high frequency transformers, etc.), electrical devices with operating frequencies greater than approximately 60 Hz, electrical or electromagnetic devices subject to frequencies greater than approximately 1.0 KHz. and/or other suitable devices. In certain embodiments, a CTC may be suitable for use in electric motors that are supplied by inverters, for example, electric motors used in hybrid electric vehicle (“HEV”), electric vehicle (“EV”), and/or other automotive applications. For purposes of this disclosure, a CTC, CTC cable, or CTC assembly may also be referred to as a continuously transposed multistrand miniature conductor assembly (“CTMMCA”) or as a micro continuously transposed conductor (“MCTC”)

In one example embodiment, a CTC may be formed by transposing any number of suitable strands. Each strand may include a conductive element, for example, a conductor formed from copper, aluminum, an alloy, one or more carbon nanotubes, or another conductive material. The conductor may be covered by one or more suitable layers of insulation (e.g., polymeric enamel, extruded thermoplastic insulation etc.). In certain embodiments, each strand may include a single conductive element. In other embodiments, each strand may include a plurality of electrically insulated conductive elements or substrands. Additionally, each strand may be formed with a wide variety of suitable dimensions. For example, each strand may have a wide variety of cross-sectional shapes, widths, thicknesses, diameters, and/or other dimensions. In certain embodiments, each strand may have a rectangular cross-sectional shape. In other embodiments, each strand may have a square, elliptical, circular, trapezoidal, triangular, hexagonal, octagonal, polygonal, or any other suitable cross-sectional shape. According to an aspect of the disclosure, each strand may have a relatively small cross-sectional area relative to conventional CTCs. For example, each strand may have a cross-sectional area that is less than or equal to approximately 0.0030 square inches or any other suitable value.

Formation of CTCs from relatively smaller strands may permit the CTCs to be implemented in smaller applications. An example application of CTC in a relatively small AC generator or an electric motor supplied by an inverter (i.e. an electric machine that may be exposed to elevated current frequencies) may utilize any number of suitable strands, such as an assembly of approximately three to approximately eleven strands, that are transposed. In certain embodiments, the transposition of the strands may be based at least in part upon the geometry of a stator or other application in which the CTC will be implemented. As desired, the strands may be arranged into at least two parallel stacks. A suitable number of strands, such as one or two strands, may be transposed at a time between the stacks. As desired, the pitch of the transposition (i.e., a longitudinal distance required to complete a transposition) and/or the number of strands in the assembly may be optimized in order to account for a wide variety of suitable factors, such as a desired rotation of the CTC, the length of a slot, and the capabilities of one or more manufacturing processes. For certain applications, the requirements for the pitch may be relatively challenging. For example, a pitch may be less than approximately one inch in length, thereby requiring the geometry of the CTC to be relatively small and/or limiting the number of strands that can be utilized.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

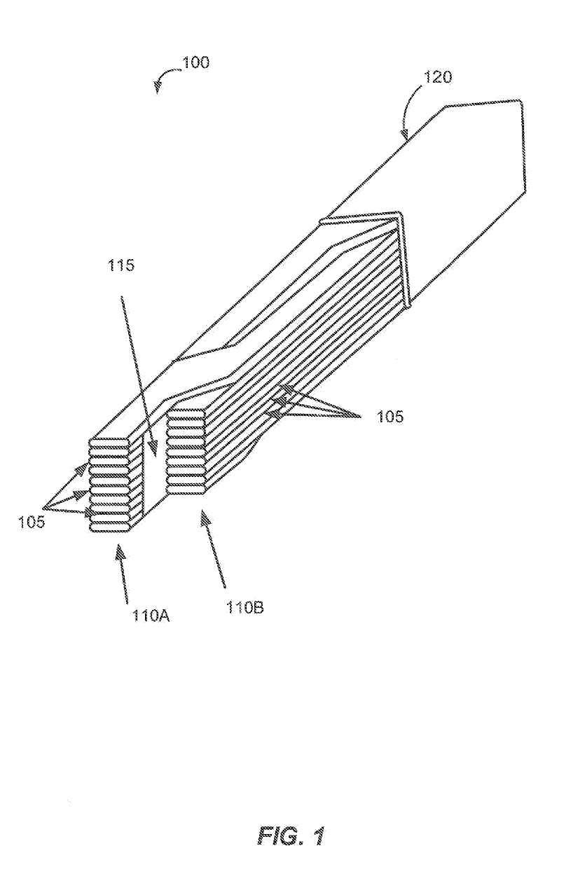

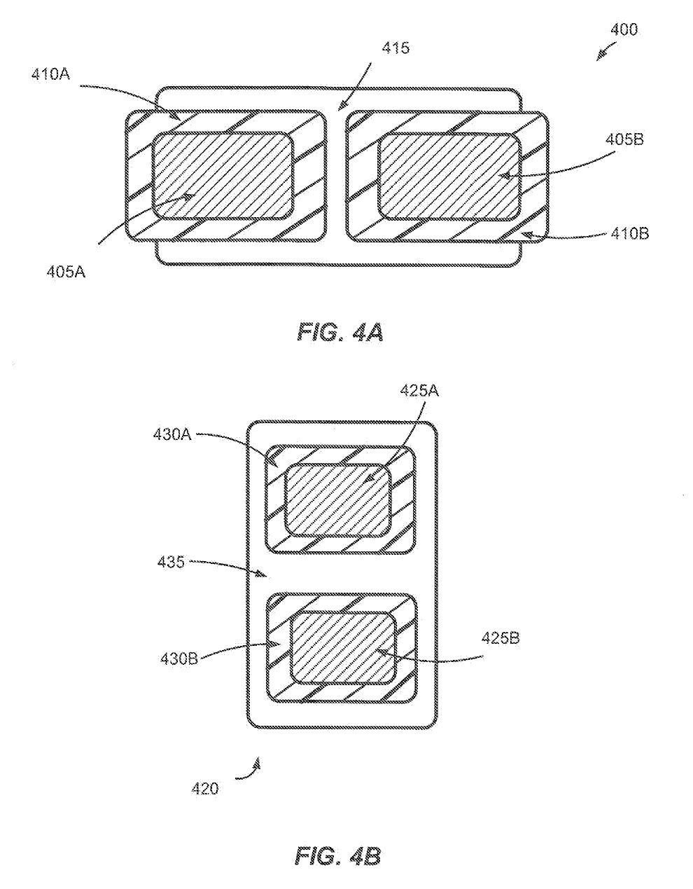

With reference to FIG. 1, a perspective view of an example CTC cable 100 or CTC 100 is illustrated in accordance with an embodiment of the disclosure. The CTC cable 100 (also referred to as a multiple parallel conductor cable) may be formed from a plurality of strands 105 or partial conductors for the overall CTC structure. In certain embodiments, each strand may include a single individually insulated conductor. In other embodiments, as shown in FIGS. 4A-4B, one or more strands may include a plurality of individually insulated conductors. Each strand (generally referred to as strand 105) may be individually insulated such that the strands are electrically isolated from one another.

The CTC cable 100 may be formed with any suitable number of strands 105 as desired in various embodiments. In certain embodiments, the CTC cable may be formed with approximately 3, 5, 6, 7, 11, 15, 19, 25, 30, 40, 50, 60, 72, 81, 85, 98, or 100 strands, or a number of strands included in a range between any two of the above values. For example, the CTC cable 100 may be formed with between approximately five (5) and approximately eighty-five (85) strands. In certain embodiments, the CTC cable 100 may be formed with between approximately three (3) and approximately eleven (11) strands. For example, the CTC cable 100 may be formed with approximately five (5) or approximately seven (7) strands. In certain embodiments, the number of strands utilized may be based at least in part upon any number of application-specific factors including, but not limited to, the size of the strands, a length of a slot into which the CTC cable 100 is inserted, a desired degree of rotation of the CTC cable 100, etc.

As shown in FIG. 1, in certain embodiments, the strands 105 may be arranged into two stacks, such as side-by-side stacks 110A. 110B. At least a portion of the strands 105 may then be interposed between the two stacks 110A, 110B. For example, the strands 105 may be interposed such that each strand successively and repeatedly takes on each possible position within a cross-section of the CTC cable 100. Additionally, in certain embodiments, the plurality of strands 105 may be connected in parallel at their ends, for example, when incorporated into a desired application.

Optionally, a suitable separator 115 may be positioned between the two stacks 110A, 110B. The separator 115 may be formed from a wide variety of suitable materials and/or combinations of materials including, but not limited to, a paper strip, Nomex®, Kapton, a polymeric film layer, an extruded polymeric layer, one or more aramid materials, glass, glass tape, and/or any suitable dielectric material(s). In certain embodiments, a separator 115 may be formed from one or more materials having a desired thermal class (e.g., NEMA Class A, B, F, H, N, R, S, etc.) and/or from one or more materials that result in the separator 115 being compatible with a desired application for the CTC cable 100. For example, the separator 115 may be designed to be compatible with certain fluids (e.g., automatic transmission fluid, etc.) or other materials that the CTC cable 100 may be exposed to when incorporated into a device.

Any number of suitable strands 105 may be transposed at a time, such as one or two strands. For example, a top and/or a bottom strand may be transposed at a time. In other words, at any given cross-sectional point along a longitudinal length of the CTC cable 100, one or two strands may be transposed or may be in the process of being transposed. As desired, one or more strands may be transposed with any suitable pitch and/or with any suitable configuration. The pitch of a transposition may correspond to a distance along a longitudinal length of the CTC cable 100 required to transpose a strand from one position (e.g., a first stack) to another position (e.g., a second stack). Examples of suitable transposition pitches that may be utilized in various embodiments include, but are not limited to, approximately 0.10, 0.125, 0.20 0.25, 0.30, 0.35, 0.4, 0.45, 0.5, 0.55, 0.6, 0.65, 0.7, 0.75, 0.8, 0.85, 0.9, 0.95, 1.0, 1.2, 1.5, 2.0, 3.0, 4.0, 5.0 inches, a pitch included in a range between any two of the above values (e.g., a pitch included in a range between approximately 0.1 and approximately 1.0 inches, etc.), or a pitch included in a range bounded on either a minimum or maximum end by one of the above values (e.g., a pitch that is less than approximately 1.0 inch, etc.). In certain embodiments, a pitch may be less than or equal to approximately 0.80 inches. Other suitable pitches may be utilized as desired.

In certain embodiments, the circulating current within a CTC application, and consequently, an optimum transposition angle and/or pitch may depend at least in part upon the slot width, the length of the stator slot, the number of strands in the stack of a CTC cable 100, the length of strands, the leakage flux in the slot and/or in the end-winding area, the end-winding diameter, and/or any number of other suitable factors. The transpositions may assist in reducing or limiting the circulating currents and/or circulating losses within the CTC cable 100. A wide variety of suitable transposition arrangements may be utilized as desired. For certain rotating machines, the best results in reducing circulating losses may be achieved with approximately 540° of rotation in and/or along the slot. In other machines, the best results may be achieved with approximately 900° of rotation. A desired or optimal rotation may be independent of the number of strands included in a CTC cable 100. In other words, a transposition pitch may be based at least in part on a number of strands in a CTC cable 100 in order to attain a desired rotation.

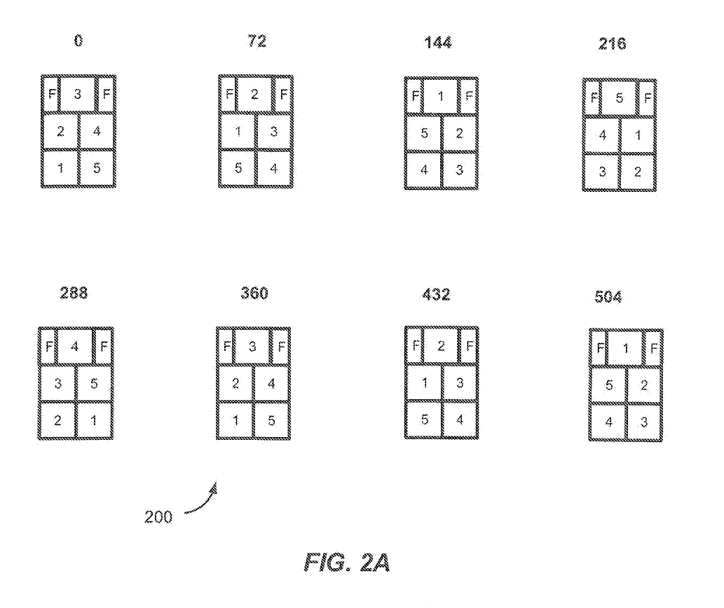

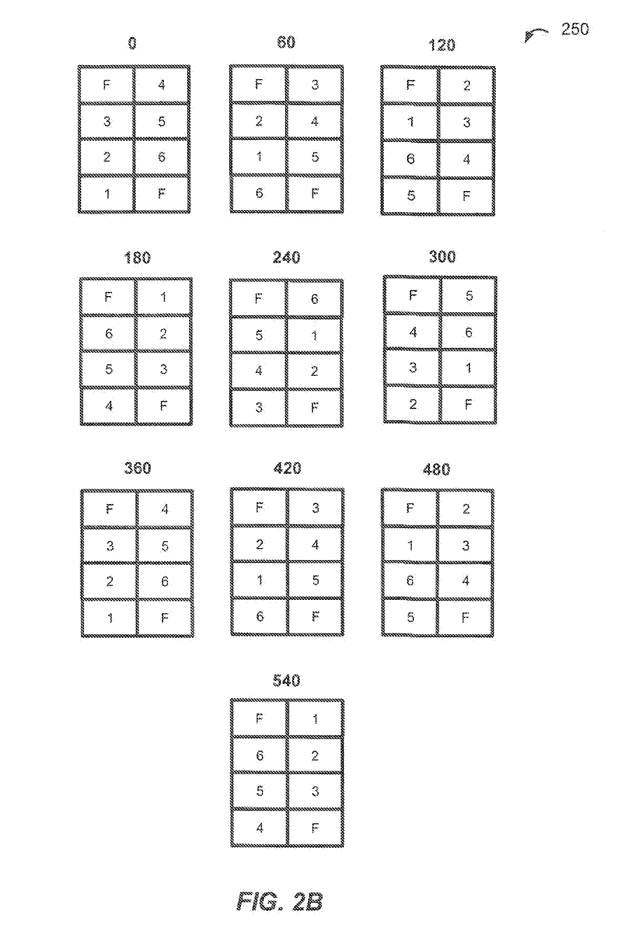

One non-limiting example of a CTC 200 that includes five (5) strands with seven (7) transpositions is illustrated in FIG. 2A. As shown, the seven transpositions of five strands may result in a final 504° rotation, which is relatively close to an optimal 540° of rotation. One strand at a time may be transposed between the two stacks. The example CTC 200 may include an odd number of strands (e.g., the illustrated five strands) arranged in two stacks with an extra strand leftover (e.g., a 2 by 2+1 configuration). Because an amount of rotation for each transposition is approximately equal to 360° divided by the number of strands, each transposition may result in approximately 72° of rotation. Accordingly, the seven transpositions may result in approximately 504° (7 times 72°) of total rotation.

FIG. 2B illustrates another example CTC 250 that contains six (6) strands and that has 540° of rotation. The strands of the CTC 250 are arranged in a double stack of three (3) strands, and nine (9) transpositions (one strand at a time) are performed along the slot of a stator fitted with the CTC 250. The CTC 250 may include an even number of strands arranged in two stacked, such as a two by three configuration. The nine transpositions therefore result in approximately 540° (9 times 60°) of total rotation. These transpositions may reduce circulating losses. A wide variety of other configurations may be utilized as desired to form a CTC cable 100. These configurations may include any suitable number of strands and/or any suitable number of transpositions.

An overall assembly of transposed conductors may have any suitable cross-sectional shape. For example, a CTC cable, such as any of CTC cables 100, 200, 250, may be formed with a rectangular overall cross-sectional shape. In other embodiments, a CTC cable 100 may be formed with a square, elliptical, trapezoidal, triangular, hexagonal, octagonal, polygonal, or any other suitable overall cross-sectional shape. As desired, one or more fillers (i.e., fillers that are each denoted as filler “F” in FIGS. 2A-2B) may be added in order to maintain a desired cross-sectional shape (e.g., a rectangular shape, etc.). For example, one or more fillers may be incorporated in order to fill any gaps between transposed strands 105 and/or to provide the CTC cable 100 with a desired overall cross-sectional shape, such as a desired rectangular shape. Filler(s) may be positioned at any suitable locations within a CTC cable 100 and/or adjacent to the strands 105 of a CTC cable 100. For example, fillers may be positioned at the top and/or the bottom of a CTC cable 100 within one or both of the stacks of strands. Any number of suitable fillers may be utilized and, in certain embodiments, the number of fillers may be based at least in part upon the number of transpositions that are made at a time within the CTC cable 100.

A filler may be formed from a wide variety of suitable materials and/or combinations of materials. In certain embodiments, a filler may be formed from one or more suitable dielectric or insulating materials, such as any of the dielectric materials discussed herein. In other embodiments, a filler may be formed from one or more suitable semi-conductive materials, such as any of the semi-conductive materials discussed herein. In certain embodiments, one or more fillers may be inserted, extruded, or applied after various transpositions are made. In other embodiments, one or more fillers may be inserted after a desired longitudinal length of the CTC cable 100 has been manufactured or after a desired number of transpositions has been completed. For example, a filler may be added prior to applying an outer wrap or coating. In yet other embodiments, an outer coating may be extruded or formed such that it fills in any gaps in the CTC cable 100.

Additionally, a CTC cable 100 or an overall assembly of transposed conductors may have any suitable cross-sectional area and/or dimensions. For example, a CTC cable 100 may have a cross-sectional area that is less than approximately 0.31, 0.30, 0.25, 0.20, 0.15, 0.10, 0.09, 0.08, 0.07, 0.06, 0.05, 0.04, 0.03, 0.025, 0.020, 0.015, or 0.010 square inches, or a cross-sectional area included in a range between any two of the above values. In certain embodiments, a CTC cable 100 may have a cross-sectional area that is less than approximately 0.020 square inches.

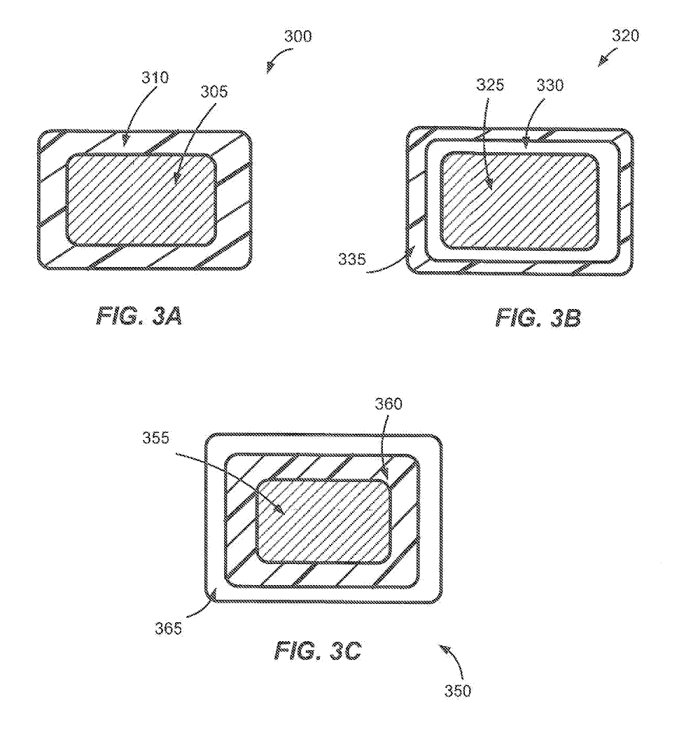

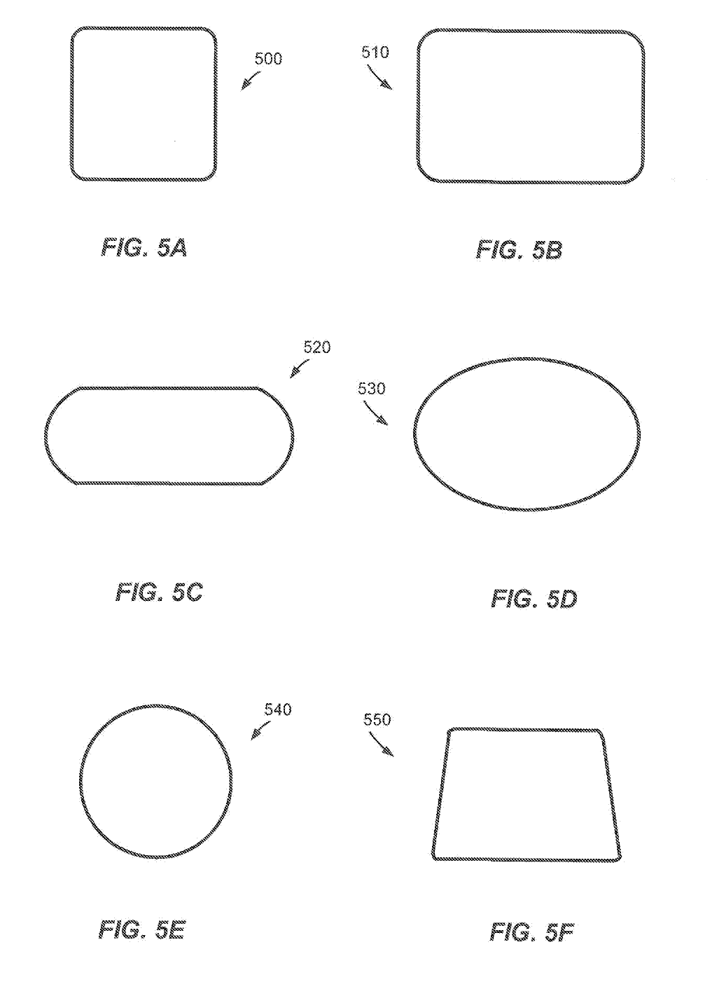

Each strand (hereinafter referred to individually as strand 105) may include one or more insulated conductors. The strands and/or conductors may include any desired cross-sectional shape, such as the rectangular shapes illustrated in FIG. 1. Additionally, a wide variety of suitable types of insulation may be utilized in association with the strands. A few non-limiting examples of conductors, conductor shapes, and insulation materials that may be utilized to form strands are described in greater detail below with reference to FIGS. 3A-5F. FIGS. 3A-3C illustrate example conductors and insulation materials. FIGS. 4A-4B illustrate a few example strands that may include a plurality of substrands (e.g., multiple conductors, etc.). FIGS. 5A-5F illustrate example cross-sectional shapes that may be utilized in association with strands as desired in various embodiments. The strands 105 incorporated into a CTC cable, such as the cable 100 of FIG. 1, may include any suitable shapes, sizes, number of conductors, and/or materials, and those discussed in FIGS. 3A-SF are not intended to be limiting.

According to an aspect of the disclosure, each strand 105 may be formed with a relatively small size compared to traditional CTC strands. In certain embodiments, each strand may have a cross-sectional area that is less than or equal to approximately 0.02, 0.015, 0.012, 0.010, 0.0098, 0.009, 0.0085, 0.008, 0.0075, 0.007, 0.006, 0.0055, 0.005, 0.004, 0.003, 0.0025, 0.002, 0.001, or 0.0005 square inches, or a cross-sectional area included in a range between any two of the above values. For example, each strand may have a cross-sectional area that is less than or equal to approximately 0.0030 square inches.

Additionally, given the wide variety of different cross-sectional shapes that may be utilized, strands may be formed with a wide variety of suitable cross-sectional dimensions. As one example, a strand having a rectangular cross-sectional shape may have a width that is less than or equal to approximately 0.10 inches and a thickness that is less than or equal to approximately 0.030 inches. Other example widths for strands include, but are not limited to, approximately 0.005, 0.01, 0.015, 0.0175, 0.02, 0.025, 0.03, 0.035, 0.04, 0.045, 0.05, 0.06, 0.07, 0.075, 0.08, 0.09, 0.10, 0.125, 0.15, 0.175, or 0.20 inches, a width included in a range between any two of the above values (e.g., a width included in a range between approximately 0.020 and approximately 0.10 inches, etc.), or a width included in a range bounded on either a minimum or maximum end by one of the above values. Other example thicknesses for strands include, but are not limited to, approximately, 0.005, 0.006, 0.007, 0.008, 0.009, 0.01, 0.0125, 0.015, 0.0175, 0.02, 0.0225, 0.025, 0.0275, 0.03, 0.035, 0.04, 0.045, or 0.05 inches, a thickness included in a range between any two of the above values (e.g., a thickness included in a range between approximately 0.010 and approximately 0.030 inches, etc.), or a width included in a range bounded on either a minimum or maximum end by one of the above values.

In certain embodiments, following transposition of a CTC cable 100, an outer wrap or coating 120 may optionally be formed around or at least partially around the CTC cable 100. In certain embodiments, an outer wrap, such as a paper wrap or an insulating tape (e.g., a Kapton tape, a Nomex® tape, etc.), may be wrapped or otherwise formed around the CTC cable 100. In other embodiments, an extruded coating may be formed around or at least partially around the CTC cable 100. The extruded coating may be formed from a wide variety of suitable materials and/or combinations of materials, such as any of the materials described below for extruded strand insulation. For example, the extruded coating may be formed from PEEK, PAEK, PPSU, PI, materials having a desired thermal class (e.g., NEMA Class A, B, F, H, N, R, S, etc.) or other properties, and/or other suitable materials. Additionally, the extruded coating may be formed with any suitable thickness, such as a thickness of approximately 0.0005, 0.001, 0.0015, 0.002, 0.0025, 0.003, 0.0035, or 0.004, 0.005, 0.01, 0.02, 0.3, 0.4, 0.5, 0.6, 0.7, 0.8, 0.9, 1.0, 1.2, or 0.15 inches, a thickness included in a range between any two of the above values, or a thickness included in a range bounded on either a minimum or maximum end by one of the above values.

In certain embodiments, an extruded coating or other outer wrap 120 may assist in holding the various strands of the CTC cable 100 together. Additionally, certain outer wraps or coatings 120 may provide protection for the CTC cable 100 when it is incorporated into a desired application. For example, an extruded coating may provide transmission fluid or other fluid resistance in an automotive application. In certain embodiments, an extruded coating may facilitate alterations to the design of an electric machine or other application. For example, an extruded coating may serve as suitable ground wall insulation. Thus, the extruded coating may allow a dedicated or separate ground wall insulation in an electric motor to be reduced or removed altogether, thereby simplifying the manufacturing operations and/or reducing the manufacturing and/or material cost of the motor.

The CTC cable 100 described above with reference to FIG. 1 is provided by way of example only. A wide variety of alternatives could be made to the illustrated cable 100 as desired in various embodiments. For example, a different number of strands, different types of strands, and/or a different strand configuration may be formed. The present disclosure envisions various CTC cable strand constructions that can be incorporated into a wide variety of different CTC cables.

As set forth above, strands of a CTC, such as strand 105, may be formed with a wide variety of suitable configurations. FIGS. 3A-3C illustrate cross-sectional views of example CTC cable strands that may be incorporated into CTC cables, such as the CTC cable 100 illustrated in FIG. 1. Each of the example strands illustrated in FIGS. 3A-3C incorporate a single conductor and insulation material. FIG. 3A illustrates an example strand 300 in which a single layer or type of insulation material is formed around a conductor. FIG. 3B illustrates an example strand 320 in which a plurality of layers of different types of insulating materials are formed around a conductor. FIG. 3C illustrates an example strand 350 in which insulation material (e.g., a single layer or multiple layers of insulation material, etc.) is formed on a conductor and a bond layer is formed on the insulation material. Each of the example strands 300, 320, 350 are discussed in greater detail below; however, it will be recognized that other strand configurations may be formed in addition to those illustrated in FIGS. 3A-3C.

Turning first to FIG. 3A, a cross-sectional view of a first example CTC cable strand 300 is illustrated. The strand 300 may include a conductor 305, and insulation material 310 may be formed around the conductor 305. The conductor 305 may be formed from a wide variety of suitable materials and or combinations of materials. For example, the conductor 305 may be formed from copper, annealed copper, oxygen-free copper, silver-plated copper, aluminum, copper clad aluminum, silver, gold, a conductive alloy, carbon nanotube(s), copper/carbon nanotube(s), copper clad carbon nanotubes, or any other suitable electrically conductive material. Additionally, the conductor 305 may be formed with any suitable dimensions and/or cross-sectional shapes. As shown, the conductor 305 may have a rectangular cross-sectional shape. However, the conductor 305 may be formed with a wide variety of other cross-sectional shapes, such as a square shape, an elliptical or oval shape, etc. A few example shapes are described in greater detail below with reference to FIGS. 5A-5F. Additionally, as desired, the conductor 305 may have corners that are rounded, sharp, smoothed, curved, angled, truncated, or otherwise formed without altering a prevailing cross-sectional shape.

In addition, the conductor 305 may be formed with any suitable dimensions. As set forth above, the conductor may be formed with a relatively small cross-sectional area and/or corresponding dimensions. For the illustrated rectangular conductor 305, the longer sides may be less than or equal to approximately 5/64 inches, and the shorter sides may be less than or equal to approximately ⅛ inches. Other suitable dimensions may be utilized as desired. A wide variety of suitable techniques may also be utilized to form or provide a conductor 305 including, but not limited to, wire drawing, conform, continuous extrusion, additive manufacture, etc. In certain embodiments, the conductor 305 may be formed in tandem with the application of insulation material onto the conductor 305. In other embodiments, a conductor 305 with desired dimensions may be preformed or obtained, and insulation material may be applied or formed in an off-line manner.

A wide variety of suitable types of insulation material 310 may be utilized as desired in various embodiments. In certain embodiments, the insulation material 310 may include one or more layers of enamel. An enamel layer is typically formed by applying polymeric varnish to the conductor 310 and then baking it in a suitable enameling oven or furnace. As desired, multiple layers of enamel may be applied to the conductor 310 until a desired number of enamel coats have been applied and/or until a desired enamel thickness or build has been achieved. Examples of suitable polymeric materials that may be utilized to form an enamel layer include, but are not limited to, polyvinyl acetal-phenolic, polyimide, polyamideimide, amideimide, polyester, polyesterimide, polysulfone, polyphenylenesulfone, polysulfide, polyphenylenesulfide, polyetherimide, polyamide, etc. In certain embodiments, a polyimide-based material (e.g., polyimide, polyamideimide, etc.) or a material including a polyimide precursor may be utilized, as these materials typically have relatively high heat resistance. Additionally, in certain embodiments, an enamel layer may be formed as a mixture of two or more materials. As desired, different enamel layers may be formed from the same material(s) or from different materials. For example, a first layer of enamel may be formed from a first material, and a second layer of enamel may be formed from a second material.

In other embodiments, the insulation material 310 may include a suitable wrap or tape, such as a polymeric tape, a polyester wrap, or a polyester glass wrap. For example, a polyimide tape or other suitable tape may be utilized. As desired, additional materials or additives (e.g., another polymeric material, etc.) may be incorporated into, embedded into, or adhered to a tape. Additionally, a tape may include a wide variety of suitable characteristic dimensions, such as any suitable thickness and/or width.

In yet other embodiments, the insulation material 310 may be formed as extruded insulation material. In certain embodiments, a single layer may be extruded to form the insulation material 310. In other embodiments, the extruded insulation material 310 may be formed via a plurality of extrusion steps and/or include a plurality of layers. Any number of layers may be utilized, such as two, three, four, or more layers. Each layer may be formed from the same material or, alternatively, at least two layers may be formed from different materials. Additionally, in certain embodiments, one or more other suitable materials may be positioned between any two extruded layers, such as adhesives, other insulation materials, etc. A wide variety of suitable materials and/or combination of materials may be utilized to form extruded insulation including, but not limited to, one or more suitable polymeric materials, thermoplastic resins or materials, and/or other suitable materials. For example, extruded insulation may be formed from and/or may include at least one of polysulfone, polyphyenylsulfone (“PPSU”), polysulfide, polyphenylene sulfide (“PPS”), polyetherketone (“PEK”), polyether-ether-ketone (“PEEK”), polyaryletherketone (“PAEK”), polyamide etherketone, thermoplastic polyimide, aromatic polyamide, extruded polyester, extruded polyketone, a fluoropolymer material, a fluoropolymer combined with a thermoplastic resin, etc. Additionally, extruded insulation material may be formed as a single material, a co-polymer, a blend of materials, or as any other suitable combination of materials.

Turning to FIG. 3B, another example CTC cable strand 320 is illustrated. In the strand 320 of FIG. 3B, one or more first or base layers of material 330 may be formed on a conductor 325, and an outer layer of insulating material 335 may be formed over the one or more base layers 330. Indeed, any suitable number of layers of insulating material may be formed around a conductor 325. The conductor 325 may be similar to the conductor 305 discussed above with reference to FIG. 3A. The base layer(s) 330 may include any number of layers of suitable material, such as one or more layers of material with enhanced adhesive properties, one or more layers of polymeric insulation material, one or more semi-conductive layers, etc.

In the event that the base layer(s) 330 include insulating material, a wide variety of different types of insulating materials and/or combinations of materials may be utilized. Additionally, any number of layers of insulating material may be utilized. In the event that multiple layers are utilized, the layers may be formed from the same material (or combination of materials) or, alternatively, at least two layers may be formed from different materials. In various embodiments, the base layer(s) 330 may include one or more layers of enamel, a suitable wrap or tape, and/or one or more extruded layers. Each of these layers may be similar to those discussed above with reference to FIG. 3A.

In other embodiments, the base layer(s) 330 may include one or more semi-conductive layers, such as a semi-conductive layer applied as an enamel layer or as an extruded layer. Alternatively, semi-conductive material may be incorporated into another layer of insulation (e.g., an enamel layer, an extruded layer, etc.). In certain embodiments, a semi-conductive layer may be formed from a material that combines one or more suitable filler materials with one or more base materials. Examples of suitable filler materials include, but are not limited to, suitable inorganic materials such as metallic materials and/or metal oxides (e.g., zinc, copper, aluminum, nickel, tin oxide, chromium, potassium titanate, etc.), and/or carbon black; suitable organic materials such as polyaniline, polyacetylene, polyphenylene, polypyrrole, other electrically conductive particles; and/or any suitable combination of materials. The particles of the filler material may have any suitable characteristic dimensions, such as any suitable diameters. In certain embodiments, the filler material may include nanoparticles. Examples of suitable base materials may include, but are not limited to, polyvinyl acetal-phenolic, polyimide, polyamideimide, amideimide, polyester, polyesterimide, polysulfone, polyphenylenesulfone, polysulfide, polyphenylenesulfide, polyetherimide, polyamide, or any other suitably stable high temperature thermoplastic or other material. Further, any suitable blend or mixture ratio between filler material and base material may be utilized. For example, the semi-conductive layer may include between approximately 3 percent and approximately 20 percent filler material(s) by weight, although other concentrations may be used. As a result of incorporating a semi-conductive layer into a strand 320, it may be possible to improve the performance of the strand 320. A semi-conductive layer may assist in equalizing voltage stresses in the insulation and/or dissipating corona discharges at or near the conductor 325. This dissipation or bleeding off of corona discharges and/or electrical stresses may improve dielectric performance and/or increase the partial discharge inception voltage (“PDIV”) of the strand 320.

Following the formation of one or more base layer(s) 330, additional insulation 335 may be formed around the base layer(s) 330. The additional insulation 335 or outer insulation may be formed from a wide variety of suitable materials, for example, enamel or extruded materials. In certain embodiments, an extruded layer may be formed around the base layer(s) 330 (e.g., enamel, etc.). In certain embodiments, the additional insulation 335 may be formed completely around an outer periphery of the base layer(s) 330. In other embodiments, the additional insulation 335 may be selectively formed around a portion of the outer periphery.

FIG. 3C illustrates yet another example CTC cable strand 350. In the strand 350 of FIG. 3C, insulation material 360 may be formed around a conductor 355, and one or more bond layers 365 may be formed on the insulation material 360. The insulation material 260 may include any suitable materials, combinations of materials, and/or layers of materials, as described above with reference to FIGS. 3A and 3B. The conductor 355 may also be similar to the conductor 305 of FIG. 3A. The bond layer(s) 365 may include one or more layers of a suitable material that facilitates thermosetting of a CTC strand 350. In any given CTC, any suitable percentage of the strands may optionally include a bond layer, such as approximately ninety percent (90%) or more of the strands. A bond layer 365 may be formed at least partially around a CTC strand 350, and a bond layer 365 may be formed from a material that has a lower melt temperature than the primary insulation or other outer insulation of the strand 350. Once a winding or other desired structure is formed from a CTC cable, the cable may be heated (e.g., by induction, etc.) in such a manner that the bond layer 365 is activated to assist in maintaining a desired structural shape of the assembly.

A bond layer 365 may be formed from a wide variety of suitable materials and/or combination of materials. In certain embodiments, the bond layer 365 may be formed from an epoxy coating, hot melt adhesive, or any other suitable thermosetting material. Examples of suitable materials that may be utilized to form a bond layer 365 include, but are not limited to, penoxy resin, cross-linking phenoxy, phenoxy associates, polysulfone, and/or similar materials. Additionally, a bond layer 365 may be formed with any suitable thickness as desired. For example, a bond layer may be formed with a thickness between approximately 0.0005 inches and approximately 0.010 inches.

Regardless of the number and/or types of insulation layers utilized in a strand (e.g., any of strands 105, 300, 320, 350, etc.), the insulation material, or any given layer of insulation material, may be formed with any suitable thickness. For example, insulation material may be formed with a thickness between approximately 0.001 inches and approximately 0.02 inches. In various embodiments, insulation material may have a thickness of approximately 0.001, 0.002, 0.003, 0.005, 0.006, 0.008, 0.01, 0.015, 0.02, 0.025, 0.03, 0.035, 0.04, or 0.05 inches, a thickness included in a range between any two of the above values, or a thickness included in a range bounded on either a minimum or maximum end by one of the above values. Additionally, in certain embodiments, insulation material may be formed to have a cross-sectional shape similar to that of the underlying conductor. For example, if a conductor has a rectangular cross-sectional shape, insulation may be formed to preserve the rectangular cross-sectional shape. In other embodiments, insulation may be formed with a different cross-sectional shape than the underlying conductor. For example, a conductor may be formed with an elliptical or non-rectangular cross-sectional shape while insulation is formed in a way that results in the insulated conductor having a rectangular cross-sectional shape.

In certain embodiments, insulation may be formed completely around a strand. In other embodiments, insulation may be formed partially around a strand. For example, insulation may be selectively formed on edges or surfaces of a strand that may contact one or more adjacent strands when the strands are incorporated into a CTC cable. In this regard, an amount of utilized insulating material and overall cost of a CTC cable may be reduced.

As desired, a strand (e.g., any of strands 105, 300, 320, 350, etc.) and/or a CTC cable that incorporates the strand may have a relatively high thermal index rating. In other words, the strand and/or the CTC cable may be suitable for continuous use at elevated temperatures without the detrimental deterioration of insuation. In certain embodiments, the strand may have a thermal index rating of at least approximately 105° C., 120° C. 155° C., 180° C., 200° C. (Class N), 220° C. (Class R), 230° C., 240° C. (Class S), or higher and therefore, be suitable for relatively continuous use at elevated temperatures without degradation of the insulation within an expected period of time (typically 20,000 hours), such as a time period set forth in one or more applicable standards (e.g., ASTM 2307, etc.). A desired thermal index rating may be determined based at least in part on an intended application for a CTC cable.

In certain embodiments, insulation may be formed or applied such that it has a relatively uniform thickness along an outer periphery and/or a longitudinal length of a strand. In other words, insulation may be formed with a target concentricity that is approximately close to 1.0. The concentricity of the insulation is the ratio of the maximum and minimum thickness of the material at any given cross-sectional point along a longitudinal length of a strand. In various embodiments, insulation material may be formed with a concentricity of approximately 1.0, 1.01, 1.02, 1.03, 1.04, 1.05, 1.07, 1.09, 1.1, 1.2, 1.3, 1.4, 1.5, 1.6, 1.7, 1.8, a concentricity included in a range between any two of the above values, or a concentricity included in a range bounded on a maximum end by any one of the above values.

In certain embodiments, insulation may be formed directly on a conductor. In other words, insulation may be formed on an underlying conductor without the use of a bonding agent, adhesion promoter, or adhesive layer. For example, extruded insulation may be formed directed on the conductor. In other embodiments, one or more other materials may be positioned between insulating material and the conductor. For example, an adhesive layer, one or more base layers of insulating material, a semi-conductive layer, and/or another suitable layer may be positioned between the conductor and a layer of insulation material.

Although the example strands 105, 300, 320, 350 illustrated in FIGS. 1 and 3A-3C incorporate a single conductor, in certain embodiments, a strand may include a plurality of individually insulated conductors that are bonded, joined, or otherwise grouped together. The use of a plurality of substrands to form a strand may further decrease the losses within a CTC. FIGS. 4A-4B illustrate example cross-sectional shapes of CTC strands that include a plurality of joined conductors, according to various illustrative embodiments of the disclosure. Turning first to FIG. 4A, a first example CTC strand 400 is illustrated. The illustrated strand 400 includes two conductors 405A, 405B, and each conductor may be electrically isolated from the other conductor. Additionally, the two conductors 405A, 405B may be bonded together.

As shown, respective insulation may be formed around each of the two conductors 405A, 405B. For example, first insulation 410A may be formed around the first conductor 405A, and second insulation 410B may be formed around the second conductor 405B. The insulation may include any suitable insulating material, such as any of the insulating materials discussed above. Once insulation has been formed around each conductor 405A, 405B, the two conductors 405A, 405B may be joined together side by side with a suitable joining coating 415. A wide variety of suitable materials and/or combination of materials may be utilized to form a joining coating 415. These materials include, but are not limited to, epoxy materials, thermoplastic resins, extruded materials, and/or adhesive materials.

In certain embodiments, the joining coating 415 may be formed between and/or around the two conductors 405A, 405B. As shown in FIG. 4A, in other embodiments, the joining coating 415 may be formed between and partially around (e.g., at least partially along the flat surfaces) the two conductors 405A, 405B. In yet other embodiments, the joining coating 415 may be formed only between the two conductors 405A, 405B. In yet other embodiments, a separate joining coating may not be utilized. For example, when insulating material (e.g., extruded insulating material, etc.) is formed, the insulating material may be formed between and around the conductors 405A, 405B in order to both individually insulate and join the conductors 405A, 405B.

FIG. 4B illustrates a second example CTC strand 420 that includes a plurality of joined conductors. The strand 420 of FIG. 4B may be similar to that of FIG. 4A; however, in the strand 420 of FIG. 4B, the two conductors 425A, 425B may be positioned flat by flat (e.g., the conductors are joined along the longer or flat edges) rather than side by side. Similar to the strand 400 of FIG. 4A, each conductor 425A, 425B may include respective insulation 430A, 430B. Additionally, the two conductors may be joined together via a suitable joining coating 435. As shown, the joining coating 435 may be applied between and around the two conductors; however, as set forth above, different joining coating configurations may be utilized. In other embodiments, the two conductors 425A. 425B may be joined together without a separate joining coating.

Although the example strands 400, 420 illustrated in FIGS. 4A and 4B depict two conductor strands, in other embodiments, any desired number of conductors may be incorporated into a strand, such as three, four, five, six, eight, nine, or another number of conductors. As a result of incorporating a plurality of conductors into a strand, it may be possible to produce a CTC cable with a higher number of total conductors while reducing the number of strands to be transposed.

Additionally, a CTC strand, such as any of the strands illustrated in FIGS. 1-4B, may be formed with any suitable cross-sectional shape. FIGS. 5A-5F illustrate a few non-limiting examples of suitable cross-sectional shapes. Turning first to FIG. 5A, an example CTC strand 500 having a square shape is illustrated. FIG. 5B illustrates an example strand 510 having a rectangular cross-sectional shape. FIG. 5C illustrates an example strand 520 having a rectangular central portion with curved or rounded edges. In other words, two sides of the strand may be relatively flat while the other edges or sides of the strand may be curved, arcuate, rounded, or elliptical. FIG. 5D illustrates an example strand 530 having an elliptical cross-sectional shape. FIG. 5E illustrates an example strand 540 having a circular cross-sectional shape. FIG. 5F illustrates an example strand 550 having a trapezoidal cross-sectional shape, which in some cases could be approximated to a triangular cross-sectional shape. A wide variety of other suitable cross-sectional shapes may be utilized as desired, such as triangular, parallelogram, hexagonal, octagonal, polygonal, semi-circular, etc. Additionally, as set forth above, one or more of the corners of a strand may be rounded, curved, angled, or truncated.

A wide variety of alternatives could be made to the illustrated strands as desired in various embodiments. Indeed, the present disclosure envisions a wide variety of suitable strand constructions. Other embodiments may include any suitable number of conductors, dimensions, cross-sectional shapes, insulation material(s), and/or combinations of layers (e.g., insulation layer(s), bond layers, adhesive layers, etc.).

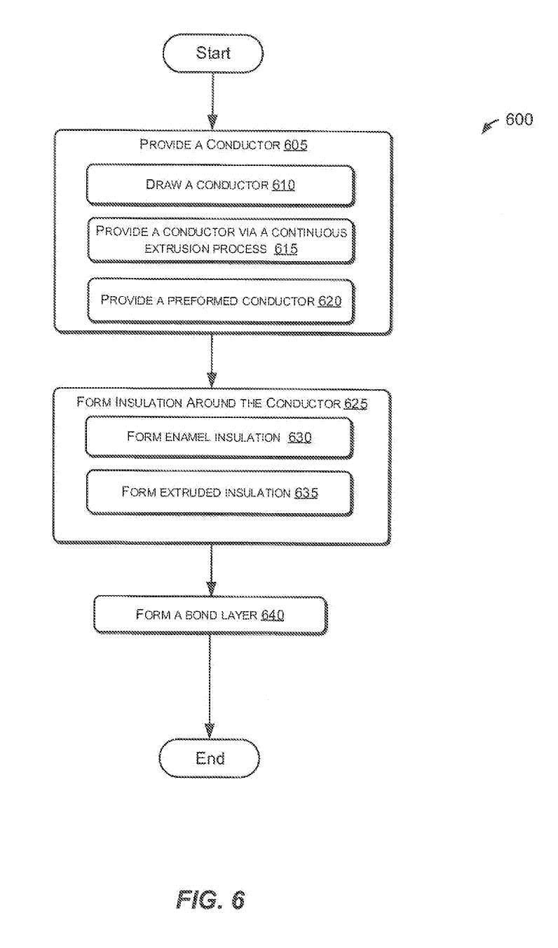

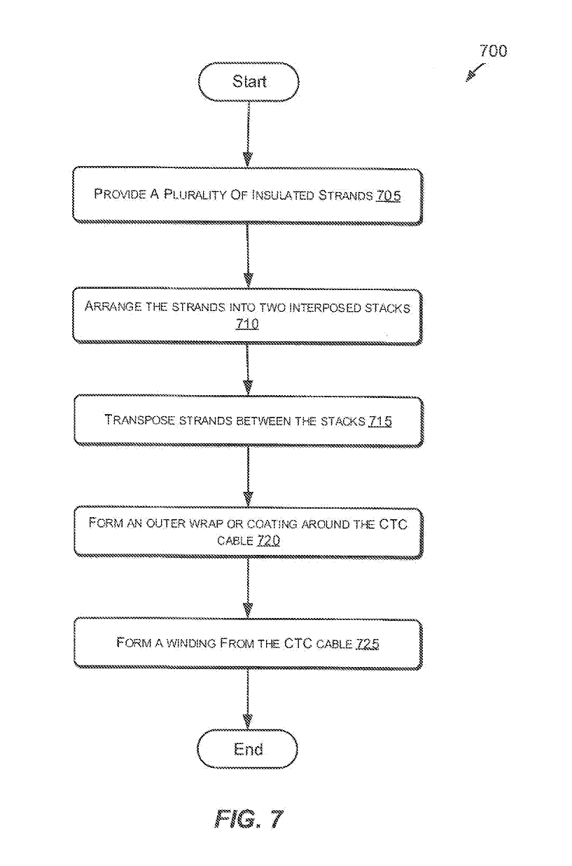

A wide variety of suitable methods and/or techniques may be utilized as desired to produce a strand and/or a CTC cable in accordance with various embodiments. In conjunction with these manufacturing techniques, a wide variety of suitable equipment, systems, machines, and/or devices may be utilized. FIG. 6 illustrates an example method 600 for forming a strand for use in a CTC cable, such as the CTC cable 100 illustrated in FIG. 1. FIG. 7 illustrates an example method 700 for forming a cable from a plurality of strands, such as a plurality of strands formed in accordance with the method 600 illustrated in FIG. 6. Each of the methods 600, 700 are discussed in greater detail below.

Turning to FIG. 6, the method 600 for forming a CTC strand may begin at block 605. At block 605, one or more conductors may be provided for incorporation into a CTC strand. A wide variety of suitable techniques and/or a wide variety of suitable wire formnnation systems may be utilized to provide the conductor(s). For example, at block 610, a conductor may be drawn from a suitable input material (e.g., rod stock, a larger diameter conductor, etc.).

As another example of providing a conductor, at block 615, a conductor may be provided via a suitable continuous extrusion or conform machine. As yet another example of providing a conductor, at block 620, a preformed conductor may be provided or received from a suitable payoff or source. In other words, a conductor may be preformed in an offline process or obtained from an external supplier or source. Thus, it may not be necessary to provide a wire formation system. The conductor may have any suitable dimensions as specified for a desired strand.

Once a conductor is provided, the conductor may optionally be passed through any number of other process components prior to reaching a downstream component or system that forms insulation (e.g., a system that forms a base layer, an extrusion system, etc.). For example, the conductor may be passed through one or more cleaning apparatus and/or an annealer. At block 625, one or more layers of insulating material may be formed around the conductor. A wide variety of suitable types of insulation layers may be formed as desired in various embodiments, such as one or more semi-conductive layers, one or more tape layers, one or more enamel layers, and/or one or more extruded layers. For example, at block 630, one or more layers of enamel may be formed on the conductor. In the event that one or more enamel layers are formed, the conductor may be passed through one or more enameling ovens. In certain embodiments, one or more dies may be incorporated into the enameling oven or provided prior to a conductor entering the oven, and varnish may be applied to the conductor as it passes through the die(s). In other embodiments, varnish may be dripped onto the conductor, wiped onto the conductor, provided by means of a varnish bath, or otherwise provided either prior to or after the conductor enters the enameling oven. After application of the varnish, the enameling oven may heat cure the varnish and/or evaporate any solvents mixed or blended with the varnish in order to complete the formation of an enamel layer. The process for applying an enamel layer to the conductor may be repeated as many times as desired in order to obtain a desired enamel build thickness and/or characteristics.

As another example of forming insulation, at block 635, one or more layers of extruded material may be formed on a conductor. As desired, the temperature of the conductor and/or any underlying layers may be controlled prior to the extrusion process via any suitable number of heating devices (e.g., heating coils, ovens, heaters, etc.) and/or cooling devices. In certain embodiments, controlling or maintaining a desired temperature (e.g., approximately 200° C. or greater, approximately 380° C. or greater, etc.) may facilitate adhesion between extruded insulation material and an underling conductor or base layer(s). In this regard, the use of a separate adhesive layer may be avoided. A wide variety of suitable extrusion devices may be configured to extrude polymeric or other suitable insulation material. These devices may include any number of suitable extrusion heads and/or other devices configured to apply a desired amount of material. As desired, the flow rates of the extruded material may be controlled in order to obtain a desired thickness. Additionally, in certain embodiments, one or more extrusion dies may be utilized to control the thickness and/or shape of the extruded insulation. In embodiments in which a CTC strand includes a plurality of conductors, extruded insulation may be either separately formed on each of the conductors or, alternatively, extruded between and at least partially around the plurality of conductors. Following the formation of insulation, the temperature of the conductor and associated insulation may be controlled as desired, for example, to attain a desired crystallinity and/or to control other suitable insulation properties.

In the event that a component strand includes a plurality of conductors (e.g., a plurality of individually insulated conductors, a joining coating may optionally be provided in order to bond or join the conductors together. In certain embodiments, a joining coating may be formed on surfaces between adjacent conductors. In other embodiments, a joining coating may be formed on surfaces between adjacent conductors and partially around the conductors. In yet other embodiments, a joining coating may be formed bother between adjacent conductors and around the conductors.

At block 640, a bond layer may optionally be formed on the strand. For example, one or more dies may be utilized to apply a bond material to the conductor. In certain embodiments, the bond material may be applied onto the insulated strand in a liquid form, and the strand may be cooled in order to solidify the bond material. In this regard, the strand may later be heated in order to activate the bond material. The method 600 may then end following block 640.

As desired in various embodiments, a plurality of the operations involved in forming a strand may be performed in a tandem or continuous manner. For example, a conductor may be drawn or otherwise provided, and one or more layers of insulation (e.g., a base layer, an extruded layer, etc.) may be formed in a tandem or in-line manner. Alternatively, a conductor may be taken up between one or more operations of the strand formation process. To the extent that operations are formed in a tandem manner, one or more synchronization devices may be utilized, such as capstans, dancers, flyers, load cells, and/or various combinations thereof. Additionally, as desired in various embodiments, the synchronization device(s) may be controlled by one or more suitable controllers (e.g., programmable logic controllers, computers, microcontrollers, embedded controllers, servers, other computing devices, etc.) in order to match or approximately match an operational speed of the tandem processes and/or devices.

Turning now to FIG. 7, an example method 700 for forming a CTC cable from a plurality of strands is illustrated. The method 700 may begin at block 705. At block 705, a plurality of strands may be provided. In certain embodiments, each of the strands may include insulation material formed on one or more associated conductors. For example, each of the strands may be formed in accordance with the method 600 of FIG. 6.

At block 710, the provided strands may be arranged into two stacks and, at block 715, at least a portion of the strands may be selectively interposed between the two stacks in order to form a CTC cable. For example, one or two strands (e.g., a top and/or bottom strand, etc.) may be transposed at a time until a desired number of transpositions has been attained. Additionally, any suitable pitch (e.g., any of the pitches discussed above with reference to FIG. 1, etc.) may be utilized for each transposition and/or any suitable degree of rotation may be attained in the CTC cable. Optionally, a suitable separator may be positioned between the two stacks. In certain embodiments, the strands may be interposed such that each strand successively and repeatedly takes on each possible position within a cross-section of the CTC cable. Additionally, in certain embodiments, the plurality of strands may be configured or adapted to be connected in parallel at their ends, for example, when incorporated into a motor or other application. A wide variety of suitable CTC stranding devices and/or systems may be utilized to form the CTC cable from the strands.

In certain embodiments, one or more fillers may be incorporated into the CTC cable during and/or after the transposition process. For example, as each transposition is made or relatively soon after a transposition is made, a filler may be inserted, applied, extruded, or formed. As another example, one or more fillers may be added or inserted after a desired longitudinal length of the CTC cable including a plurality of transpositions has been manufactured. The filler(s) may be incorporated in order to fill any gaps between transposed strands and/or to provide the CTC cable with a desired overall cross-sectional shape. As set forth above, filler(s) may be positioned at any suitable locations within a CTC cable and any number of suitable fillers may be utilized. Additionally, a filler may be formed from a wide variety of suitable materials and/or combinations of materials.

Additionally, in certain embodiments, the formation of a plurality of strands and the formation of a CTC cable from the strands may be completed in a tandem process. In other embodiments, the formation of the strands and the CTC cable may be completed in separate offline processes. For example, formed strands may be accumulated and taken up, and the strands may subsequently be provided to a CTC stranding device to form a CTC cable.

At block 720, which may be optional in certain embodiments, the strands of the CTC cable may be consolidated together. A wide variety of suitable process and/or techniques may be utilized to consolidate the strands. In certain embodiments, an outer wrap or coating may be formed around the CTC cable. For example, a paper wrap or polymeric tape wrap may be formed around the CTC cable. As another example, an extruded outer coating may be formed around the CTC cable. As set forth above, an outer wrap or coating may be formed from any suitable material and/or combination of materials. In other embodiments, both an outer wrap and an extruded outer coating may be formed around the CTC cable. In certain embodiments, once the strands have been transposed and after one or more optional outer wraps or layers have been formed, one or more suitable markings may be printed or otherwise formed on an outer surface of the CTC cable. For example, one or more markings that identify each transposed section may be formed on an outer surface. These markings may facilitate relatively easier assembly of the CTC cable into a desired application. As another example, one or more alphanumeric characters (e.g., text, a company name, etc.) and/or logos may be printed or otherwise formed on an outer surface of the CTC cable.

At block 725, a wide variety of suitable configurations may be optionally formed utilizing the CTC cable or the interposed strands. For example, a suitable winding or other CTC structure may be formed for a motor, generator, rotating machine, load reactor, inductor, transformer, stator, or other electrical device. Typically, a winding is formed in an offline manner subsequent to the formation of a CTC cable. For example, a CTC manufacturer may form the CTC cable, and the cable may be shipped to motor or other electrical device manufacturer that subsequently forms a suitable winding. In certain embodiments, a relatively continuous winding may be incorporated into an electrical device. In other embodiments, a CTC cable may be divided into sections having desired lengths, and sections of a winding (e.g., hairpins, etc.) may be formed from each of the sections. Optionally, once the winding is formed, the CTC cable may be heated in order to activate the bond layers incorporated into the CTC cable. The method 700 may end following block 725.

The operations described and shown in the methods 600, 700 of FIGS. 6 and 7 may be carried out or performed in any suitable order as desired in various embodiments. Additionally, in certain embodiments, at least a portion of the operations may be carried out in parallel. Furthermore, in certain embodiments, less than or more than the operations described in FIGS. 6 and 7 may be performed.

In certain embodiments, specialized equipment may be utilized to form CTC cables in which the strands have relatively small cross-sectional sizes. Indeed, conventional CTC formation equipment and/or transposition equipment is typically suitable to process and transpose strands having a minimum thickness of approximately 0.040 inches and a minimum width of approximately 0.120 inches. Additionally, the transposition pitch of conventional CTC equipment exceeds approximately one inch. In order to form CTC cables from smaller strands, specialized equipment may be developed and utilized that is capable of handling the strands and forming transpositions with a suitable pitch.

Conditional language, such as, among others, “can,” “could,” “might.” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A continuously transposed conductor (CTC) cable comprising:
a plurality of electrically insulated strands arranged in two stacks with the plurality of strands successively transposed between the two stacks, each strand comprising:
a conductor, and
insulation formed at least partially around the conductor, wherein each strand has a cross-sectional area that is less than approximately 0.0030 square inches.

2. The CTC cable of claim 1, wherein the plurality of strands comprises between approximately three and approximately one hundred strands.

3. The CTC cable of claim 1, wherein the plurality of strands comprises between approximately three and approximately eleven strands.

4. The CTC cable of claim 1, wherein each strand comprises a rectangular cross-sectional shape with a width between approximately 0.020 inches and 0.10 inches and a thickness between approximately 0.010 inches and approximately 0.030 inches.

5. The CTC cable of claim 1, wherein the CTC cable has a cross-sectional area that is less than approximately 0.020 square inches.

6. The CTC cable of claim 1, wherein each transposition is formed with a pitch between approximately 0.1 inches and 1.0 inches.

7. The CTC cable of claim 1, wherein each transposition is formed with a pitch that is less than or equal to approximately 0.80 inches.

8. The CTC cable of claim 1, wherein each of the plurality of strands has one of a rectangular, square, elliptical, circular, triangular, trapezoidal, hexagonal, octagonal, or polygonal cross-sectional shape.

9. The CTC cable of claim 1, wherein at least one of the plurality of strands comprises a plurality of conductors joined or bonded together.

10. The CTC cable of claim 1, wherein the CTC cable has a rectangular cross-sectional shape.

11. The CTC cable of claim 1, wherein the CTC cable has one of a square, triangular, trapezoidal, hexagonal, octagonal, or polygonal cross-sectional shape.

12. The CTC cable of claim 1, further comprising a wrap formed around the plurality of transposed strands.

13. The CTC cable of claim 1, further comprising an extruded coating formed around the plurality of transposed strands.

14. The CTC cable of claim 1, wherein at least a portion of the plurality of strands further comprise a bond layer formed on the insulation.

15. A continuously transposed conductor (CTC) cable comprising:
a plurality of strands arranged in two stacks with the plurality of strands successively transposed between the two stacks, each strand comprising:
a conductor, and
insulation formed at least partially around the conductor,
wherein the plurality of strands has a combined cross-sectional area that is less than approximately 0.020 square inches.

16. The CTC cable of claim 15, wherein each of the plurality of strands has a cross-sectional area that is less than approximately 0.0030 square inches.

17. The CTC cable of claim 15, wherein the plurality of strands comprises between approximately three and approximately eleven strands.

18. The CTC cable of claim 15, wherein each transposition is formed with a pitch that is less than or equal to approximately 0.80 inches.

19. The CTC cable of claim 15, wherein at least one of the plurality of strands comprises a plurality of conductors joined or bonded together.

20. An electrical device comprising:
at least one winding of a continuously transposed conductor (CTC) cable, the CTC cable comprising:
a plurality of electrically insulated strands electrically connected in parallel at their ends, each strand comprising (i) a conductor and (ii) an insulation layer formed at least partially around the conductor, wherein each strand has a cross-sectional area less than approximately 0.0030 square inches.

21. The electrical device of claim 21, wherein the electrical device comprises an electric motor or generator.

22. The electrical device of claim 21, wherein the electrical device comprises a load reactor, an inductor, or a transformer.

23. The electrical device of claim 21, wherein the electrical device comprises an electrical device with an operating frequency greater than approximately 60 Hz.

24. The electrical device of claim 21, wherein the electrical device comprises an electrical device subject to frequencies exceeding approximately 1 KHz.
